(19) United States
(12) Patent Application Publication
(10) Pub. No.: US 2007/0043930 A1
(43) Pub. Date: Feb. 22, 2007

(54) Performance of a data processing apparatus

(76) Inventors: Stephen John Hill, Austin, TX (US); Glen Andrew Harris, Austin, TX (US); David James Williamson, Austin, TX (US)

Correspondence Address: NIXON & VANDERHYE, PC, 901 NORTH GLEBE ROAD, 11TH FLOOR, ARLINGTON, VA, 22203, US

(21) Appl. No.: 11/204,399

(22) Filed: Aug. 16, 2005

(51) Int. Cl. G06F 9/30

(52) U.S. Cl. 712/214

(57) ABSTRACT

Techniques for improving the performance of a data processing apparatus are disclosed. A data processing apparatus operable to process instructions and operable to determine, prior to each instruction being issued for execution, when resources associated with that instruction are predicted to be available for use by succeeding instructions is provided. The data processing apparatus comprises scoreboard logic operable to store an indication of when resources associated with an instruction to be issued are predicted to be available for use by succeeding instructions; issue logic operable to determine, by reference to the scoreboard logic, when the instruction can be issued for execution, the issue logic being further operable in the case that the instruction falls within a class of instructions which have been designated as instructions for which it is uncertain when resources associated with those instructions will be available for use by succeeding instructions, to prevent succeeding instructions from issuing until all preceding instructions have been executed; and inhibit override logic operable to detect when the instruction to be issued falls within a sub-class of instructions, to review all preceding instructions and, in the event that the they all fall within the sub-class of instructions, to cause the issue logic to enable the succeeding instruction to be issued for execution even when all preceding instructions have not been completed. Enabling the succeeding instruction to be issued without first draining all the preceding instructions reduces the latency period experienced prior to that instruction being issued. It will be appreciated that this approach can significantly improve the performance of the data processing apparatus.

### FIELD OF THE INVENTION

The present invention relates to techniques for improving the performance of a data processing apparatus.

### BACKGROUND OF THE INVENTION

In a conventional pipelined data processing apparatus, in the event that a dependency between instructions is determined during the execution of those instructions, a stall signal is propagated back through the pipeline in order to stall succeeding instructions. It is important to stall the dependent instructions because, as a result of the dependency, one or more of these instructions may need to use the result of a preceding instruction and that result may not yet be available.

Whilst stalling ensures that instructions only ever execute with valid data, the determination that there is a dependency between instructions will usually be available late in the processing cycle. Hence, the time remaining to propagate the stall signal back through the pipeline before the end of the processing cycle is relatively short.

It will be appreciated that a problem with this approach is that as the processing speed of the pipeline increases, the time available to propagate the stall signal reduces further until it becomes a limiting factor in the processing speed of the data processing apparatus.

In order to alleviate this problem, a static-scheduling technique can be adopted. In statically-scheduled instruction issue logic, the instructions are only ever issued in the order in which they exist in the program. In addition scoreboard logic is provided. As instructions are issued a prediction of when the results of that instruction will be available for use by following instructions, and the destination registers to which those results will be written, are effectively reserved by updating the relevant entries associated with those resources in the scoreboard. The scoreboard can then be referred to prior to issuing succeeding instructions to ensure that those succeeding instructions are not issued for execution at a time which would require the succeeding instruction to access a result that is not yet available from an instruction preceding it in program order. If the scoreboard indicates that a conflict will occur then the succeeding instructions are delayed from being issued until the prediction has progressed enough that the required result will be available to the succeeding instruction at the required time.

Hence, by using a scoreboard, it can be assumed that once an instruction is issued its progress is considered to be deterministic since it can be assumed that all the data and resources required by that instruction will be available at the appropriate time to enable the instruction to execute validly and its result will be available, at the latest, at the point predicted at the time the instruction was issued and the scoreboard entry corresponding to its destination register was written.

It will be appreciated the statically-scheduled approach overcomes the drawbacks of having to propagate the stall signal back through the pipeline because the decision as to whether there is a dependency between instructions can be predetermined prior to the instruction ever being issued for execution. Thus, using the scoreboard technique enables a determination to be made much earlier in the processing cycle as to whether the instruction needs to be delayed and avoids propagating a stall signal to as many pipeline stages It will be appreciated that this approach can improve the performance of the data processing apparatus.

However, the scoreboard technique relies on predictions relating to the availability of the resources. In the event that, for whatever reason, it transpires that resources are not available for use by an instruction at the time predicted then the instruction will execute regardless and will generate invalid data. An instruction may generate invalid data because operands may not be available due to, for example, a cache miss which would require the data to be retrieved from a higher level memory, and which would take much more time than predicted.

To deal with any invalid execution, a determination is made by the data processing apparatus, prior to any architectural state associated with the executed instruction being committed, as to whether the instruction has executed validly. If an instruction executes validly then the architectural state is committed and the instruction retired. However, in the event it is determined that an instruction has not executed validly then any architectural state associated with the executed instruction is preserved. In addition a recovery mechanism must be activated to ensure the instruction is executed validly. The recovery mechanism typically takes more cycles to execute the instruction than would be required in normal operation.

Typically, the recovery mechanism uses a pipeline which stores details of all the instructions that have been issued for execution but have not yet retired. When an error occurs, the main pipeline is reset and the instructions from the recovery pipeline are issued (in their original sequence) back through the pipeline. It is anticipated that the results will be available as predicted for the instruction from the recovery pipeline. In the rare occasion that this is not the case the recovery mechanism would operate again. Whilst it will be appreciated that causing a recovery operation to occur will significantly impact on the performance of the data processing apparatus, the statistical occurrence of such recovery operations is generally relatively low in comparison to the number of instructions which execute as predicted. Hence, the overall impact on performance by such recovery operations can be relatively low.

It will be appreciated that in order to reduce the number of recovery operations that need to be performed, the prediction of when execution of an instruction will cause various resources to be available for succeeding instructions needs to be as accurate as possible. If the prediction is overly optimistic, then the number of recovery operations which occur will increase, which could adversely affect overall performance. Conversely, if the prediction is too pessimistic, then succeeding instructions will unnecessarily be delayed from being issued, which could also adversely affect overall performance. Hence, it will be appreciated that the scoreboard and recovery operation technique works well when these predictions can on average be made accurately.

However, the execution of some instructions cannot be accurately predicted. This may be because the instructions require interaction with a peripheral device or some other device outside the main execution pipeline stages of the data processing apparatus, and the time at which those devices respond can vary significantly. For example, the instruction may be associated with a co-processor or a slave device which may have any number of outstanding instructions to be processed prior to the instruction currently being issued. In these circumstances, the slave device may update a destination register or memory at any time within a wide range of processing cycles, which is not easy to predict.

Because the timing is not easy to predict, then, if any prediction made at all, the prediction may be overly optimistic in which case a recover operation will occur, alternatively, the prediction may be overly pessimistic, in which case the instruction issue will be routinely stalled for an unnecessary period of time.

In addition the execution of some instructions may, in principle, be predictable but not implemented in the processor because the logic required to perform that prediction would be too expensive or complex.

Hence, the occurrence of such instructions cannot easily be handled in a manner which provides an acceptable level of performance. Accordingly, in these situations, the instruction is typically issued and succeeding instructions are simply stalled until an indication has been provided that the instruction has been executed and any associated registers or memory updated. This avoids the need for recovery operations to occur and only causes processing to be delayed for a limited period whilst executing that instruction. Typically, the average period of time before said indication is made is not as long as the longest possible delay for the result of the instruction, otherwise simply statically scheduling the instruction using its longest possible delay would offer similar performance, but the average period of time before said indication is made is typically long enough to have a significant detrimental effect on performance.

It is desired to provide a technique for improving the performance of such a statically scheduled data processing apparatus.

### SUMMARY OF THE INVENTION

Viewed from a first aspect, the present invention provides a data processing apparatus operable to process instructions and operable to determine, prior to each instruction being issued for execution, when resources associated with that instruction are predicted to be available for use by succeeding instructions, the data processing apparatus comprising: scoreboard logic operable to store an indication of when resources associated with an instruction to be issued are predicted to be available for use by succeeding instructions; issue logic operable to determine, by reference to the scoreboard logic, when the instruction can be issued for execution, the issue logic being further operable in the case that the instruction falls within a class of instructions which have been designated as instructions for which it is uncertain when resources associated with those instructions will be available for use by succeeding instructions to prevent succeeding instructions from issuing until all preceding instructions have been executed; and inhibit override logic operable to detect when the instruction to be issued falls within a sub-class of instructions, to review an immediately succeeding instruction and, in the event that said immediately succeeding instruction also falls within said sub-class of instructions, to cause said issue logic to enable said succeeding instruction to be issued for execution even when all preceding instructions have not been completed.

The present invention recognises that whilst stalling succeeding instructions when it can not easily be predicted when resources associated with an instruction to be issued will become available ensures that no pipeline reset and recover of instructions will need to occur, such an approach can be extremely inefficient and can adversely affect the performance of the data processing apparatus. This inefficiency arises due to the requirement that succeeding instructions are stalled until the issued instructions have finished executing. The issued instructions can often take a long period of time to execute. Hence, stalling can introduce a large latency period prior to any subsequent instructions being issued. In the event that the next instruction is also an instruction for which it can not easily be predicted when resources associated with that instruction will become available (i.e. the next instruction also falls within that class of instructions), then the instructions subsequent to that instruction will also be stalled until that instruction has also been executed. This further stalling can also introduce a further large latency period prior to any subsequent instruction being issued. Hence, the present invention recognises that by stalling each time an instruction which falls within the class is encountered, delays occur due to the introduction of a large latency period between instructions being issued. This can significantly reduce the throughput of the data processing apparatus.

Accordingly, inhibit override logic is provided which detects when the instruction to be issued falls within a sub-class of the class of instructions. In the event that the succeeding (the next) instruction also falls within the same sub-class of instructions then the inhibit override logic ensures that the issue logic does not prevent that next instruction from issuing, even when there are previously issued instructions still being executed. Enabling the next instruction to be issued without first draining all the preceding instructions reduces the latency period experienced prior to that instruction being issued. It will be appreciated that this approach can significantly improve the throughput of the data processing apparatus.

The present invention recognises that the sub-class of instructions includes instructions which can be guaranteed to execute correctly regardless of when the results of other instructions that have been issued but not completed are available, provided that all instructions between the instruction about to issue and the oldest instruction also in the sub-class that has been issued but not completed, upon which a dependency exists, are also in the sub-class.

In one embodiment, the inhibit override logic is operable, in the event that each immediately succeeding instruction also falls within the sub-class of instructions, to cause the issue logic to sequentially issue each immediately succeeding instruction falling within the sub-class of instructions until an instruction not falling within the sub-class of instructions is encountered.

It is recognised that it is often the case that instructions which fall within the sub-class will be issued in sequential bursts. Hence, each instruction which falls within the sub-class can be issued without having to wait for all earlier instructions to execute. Only when an instruction that does not fall within the sub-class is encountered will that instruction be prevented from being issued. It will be appreciated that such an approach will significantly improve the performance of the data processing apparatus when sequential bursts of instructions falling within the sub-class are encountered.

In one embodiment, once the instruction not falling within the sub-class is encountered, the inhibit override logic is operable to cause the issue logic to prevent that instruction and succeeding instructions from issuing until all preceding instructions have been executed.

The class of instructions will include many different instructions which, for one reason or another, it may be very difficult using the information and resources available (although not necessarily impossible) to predict when resources associated with those instructions will be available for use by succeeding instructions. For example, amongst the class of instructions for which the time at which a result will be available cannot be accurately predicted it is sometimes possible to find sub-classes of instructions for which it is possible to determine that instructions in the sub-class will produce correct results when issued. For example it may be possible to an issue instruction that is associated with a particular co-processor or slave device since it can be predetermined that these instructions will produce correct results when issued.

In one embodiment, the class of instructions includes those instructions where the time taken to modify architectural state associated with those instructions can not be accurately predicted.

For example, it may not be possible to predict the time taken just from the decoded instruction itself.

In one embodiment, the class of instructions includes those instructions having a variable execution time which can not readily be determined prior to the instruction being issued for execution.

In one embodiment, the class of instructions includes those instructions for which the likelihood of accurately predicting when resources associated with those instructions will be available for use by succeeding instructions is lower than the likelihood of not accurately predicting when resources associated with those instructions will be available for use by succeeding instructions.

In one embodiment, the sub-class of instructions includes those instructions which cause data to be accessed in a slave device.

In one embodiment, the sub-class of instructions includes those instructions which cause data to be accessed in a slave device and the time taken for the slave to respond varies depending on the number of pending instructions in that slave device.

In one embodiment, the data processing apparatus further comprises a processor core, the scoreboard logic, the issue logic and the inhibit override logic being provided as part of the processor core and the class of instructions includes instructions which cause a data transfer to occur from a slave device to the processor core.

In one embodiment, the sub-class of instructions includes those instructions which cause no change in the architectural state associated with the processor core.

In one embodiment, the sub-class of instructions includes those instructions which only change the architectural state of the slave device.

In one embodiment, the issue logic is operable to receive an indication of whether the instruction falls within the class of instructions.

In one embodiment, the issue logic is operable to receive from decode logic the indication of whether the instruction falls within the class of instructions.

In one embodiment, the resources include registers or memory operable to store operands associated with instructions.

In one embodiment, the resources include logic operable to execute instructions.

In one embodiment, the issue logic is further operable to prevent, in the case that the instruction falls within the class of instructions which have been designated as instructions for which it is uncertain when resources associated with those instructions will be available for use by succeeding instructions, an indication from being made in the scoreboard logic of when resources associated with the instruction will be available for use by succeeding instructions.

Viewed from a second aspect, the present invention provides a data processing apparatus for processing instructions and for determining, prior to each instruction being issued for execution, when resources associated with that instruction are predicted to be available for use by succeeding instructions, the data processing apparatus comprising: scoreboard means for storing an indication of when resources associated with an instruction to be issued are predicted to be available for use by succeeding instructions; issue means for determining, by reference to the scoreboard logic, when the instruction can be issued for execution, for preventing, in the case that the instruction falls within a class of instructions which have been designated as instructions for which it is uncertain when resources associated with those instructions will be available for use by succeeding instructions, succeeding instructions from issuing until all preceding instructions have been executed; and inhibit override means for detecting when the instruction to be issued falls within at least part of the class of instructions, for reviewing an immediately succeeding instruction and, in the event that the immediately succeeding instruction also falls within the at least part of the class of instructions, for causing the issue means to enable the succeeding instruction to be issued for execution even when all preceding instructions have not completed execution.

Viewed from a third aspect, the present invention provides a method of processing instructions comprising: storing an indication of when resources associated with an instruction to be issued are predicted to be available for use by succeeding instructions; determining, by reference to the indication, when the instruction can be issued for execution; preventing, in the case that the instruction falls within a class of instructions which have been designated as instructions for which it is uncertain when resources associated with those instructions will be available for use by succeeding instructions, succeeding instructions from issuing until all preceding instructions have been executed; and detecting when the instruction to be issued falls within a sub-class of instructions, reviewing an immediately succeeding instruction and, in the event that the immediately succeeding instruction also falls within the sub-class of instructions, causing the succeeding instruction to be issued for execution even when all preceding instructions have not been completed.

### BRIEF DESCRIPTION OF THE DRAWINGS

Embodiments of the present invention will now be described with reference to the accompanying drawings in which:

FIG. 1 illustrates a data processing apparatus incorporating inhibit override logic according to an embodiment of the present invention;

FIG. 2 is a flow chart illustrating the operation of the data processing apparatus incorporating the inhibit override logic; and

FIG. 3 is a timing diagram illustrating the operation a data processing apparatus with and without the inhibit override logic.

### DESCRIPTION OF THE EMBODIMENTS

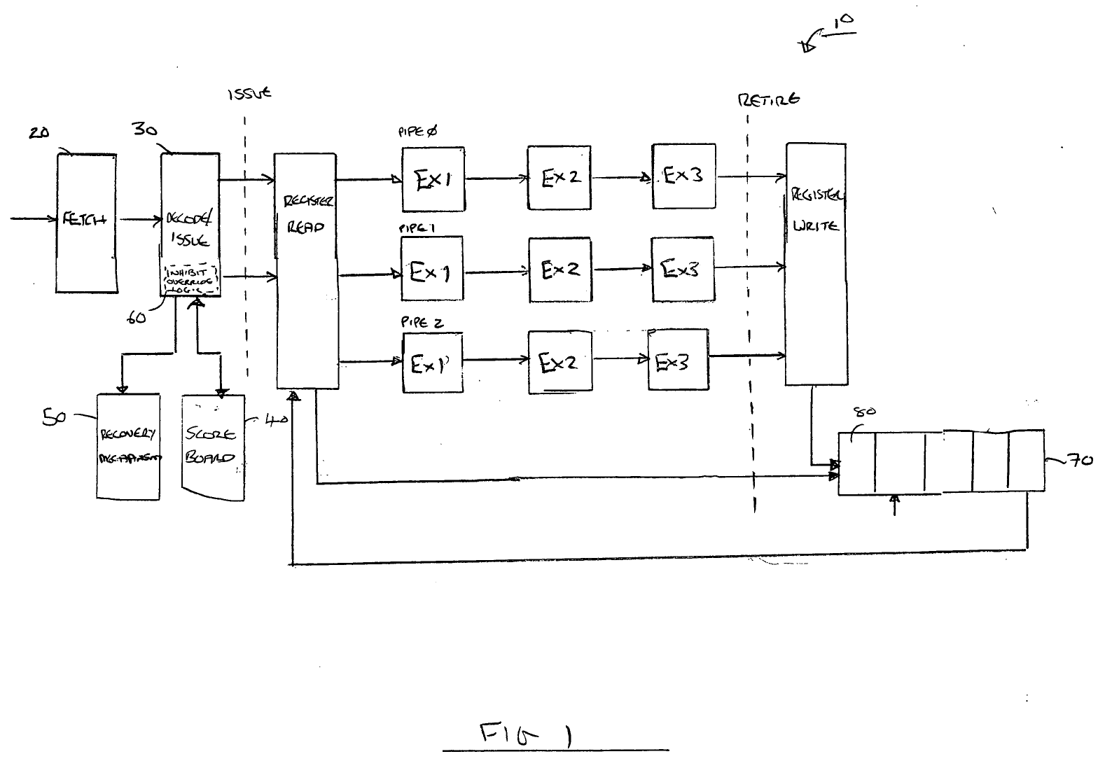

FIG. 1 illustrates a data processing apparatus, generally 10, incorporating inhibit override logic 60 according to an embodiment of the present invention. The data processing apparatus 10 is a super-scalar statically-scheduled data processing apparatus. The data processing apparatus 10 has, in this example, three parallel pipelines (pipe 0, pipe 1 and pipe 2) to which instructions may be issued concurrently for execution.

The data processing apparatus 10 has fetch logic 20 which fetches instructions to be processed. The fetch logic 20 passes the fetched instructions to the decode/issue logic 30 for decoding and for issuing of the decoded instructions to subsequent stages in the pipeline.

The decode/issue logic 30 interacts with a scoreboard 40 which stores an indication of the resources currently allocated to other instructions which have already been issued. The scoreboard 40 provides an indication of when the results will be available for use by subsequent instructions.

The information relating to the availability of the results is predicted by the decode/issue logic 30 when issuing instructions, based on the instruction being issued. For example, when an instruction is to be issued which will cause the contents of a register to be changed, the decode/issue logic 30 will make a prediction of which future processing cycle the contents of the registers will be available for use by succeeding instructions. For example, if the instruction is a shift instruction for which it is expected that the source operand of the instruction will have been read and/or the destination operand of the instruction is expected to have been calculated within two processing cycles of the instruction being issued, then the scoreboard 40 may be updated to indicate that the resources associated with the shift instruction will be available in, for example, two processing cycles. Similarly, if the instruction is a multiply instruction then the scoreboard 40 may be updated to indicate that the result of that multiply instruction will be available in, for example, four processing cycles.

Accordingly, the scoreboard 40 can readily provide an indication of which registers, are associated with executing instructions and provide an indication of when the associated results will become available.

Hence, the decode/issue logic 30, upon receipt of an instruction to be issued, will refer to the scoreboard 40 in order to determine whether there is any dependency between the instruction to be issued and any instructions that have been issued and which may be currently in the pipeline. For example, if the instruction received by the decode/issue logic 30 is an add instruction which uses the contents of the register R1 and R2 and stores the result in R3, then the decode/issue logic 30 will refer to the scoreboard 40 to determine whether registers R1 and R2 are currently assigned to other instructions. The decode/issue logic 30 will then prevent the issue of the instruction into the pipeline until an appropriate time when the required resources will become available at the time needed by that instruction (it will be appreciated that this need not necessarily be the cycle during which the earlier instruction is predicted to retire but may be an earlier cycle when the data associated with those registers is predicted to be available). In this way, instructions are processed in the order which they occurred in the program and it is possible to assume that once an instruction has been issued all the data and resources it requires to be able to execute correctly should be available when required.

When issuing the instruction, the decode/issue logic 30 will update the scoreboard 40 with the prediction of when the resources associated with that instruction will be available to subsequent instructions. For example, in the event of an add instruction which uses the contents of the register R1 and R2 and stores the result in R3, the decode/issue logic 30 may update the scoreboard 40 to indicate that the destination register, R3, will have the result of the operation available in, for example, three clock cycles.

However, it will be appreciated that the information stored in the scoreboard 40 is simply a prediction of when the resources are expected to be available. In reality, it is possible that, in certain circumstances, the resources will not be updated and made available within the time that was predicted. Accordingly, when this occurs, the data used by subsequent instructions may be invalid. Hence, a recovery mechanism 50 is provided which is utilised to recover from this situation.

Should the prediction of when resources associated with an instruction are expected to be available be incorrect, the data processing apparatus 10 will detect that a recovery operation is required and recovery will be initiated.

It will be appreciated that the prediction of when resources associated with any particular instruction will become available needs to be done as accurately as possible to avoid extra delays imposed by the recovery mechanism. If the prediction is overly optimistic, then the resources may not be available when required which will require a recovery operation to be performed. Performing the recovery operation is not trivial and has a marked impact on performance. However, being consistently pessimistic about when data or resources are expected to be available will also have a consistent impact on performance since in many cases, the resources may actually available much earlier than predicted. Hence, it is necessary to ensure that the likelihood of the prediction being correct is significantly higher than the likelihood that the prediction is not correct.

With this is mind, it becomes clear that there is a class of instructions for which it is not easy to reliably predict when resources associated with those instructions will become available; that is not to say that it would be absolutely impossible to predict when the resources will be available but that the amount of resources required to make that prediction are such that it is not practical to predict despite the prediction being at least theoretically possible. Hence, for such instructions, making any prediction at all is likely to impact on the performance of the data processing apparatus 10 since there is a significant likelihood that the prediction is not correct. These instructions are typically those instructions for which there is some type of dependency with resources outside the main pipeline. For example, such instructions include those which interact with a slave device 70 such as a digital signal processor, audio or video processor, a co-processor or any other device which may be not directly within the pipeline. These devices are typically decoupled in some way from the main pipeline. Also, the devices may have an unknown number of pending instructions, stored in an instruction buffer 80, which must be executed before the issued instruction can be executed. Accordingly, if such an instruction causes, for example, a resource such as a register or memory location to be updated in some way as a result of the execution of that instruction in one of these devices then it is likely that the time taken to modify that resources can not be accurately predicted. This difficulty in prediction may be due to a variable execution time caused by the fact that the device may have any number of outstanding instructions to execute prior to the issued instruction.

In a microprocessor that retires instructions in program order, typically, these difficult to predict instruction would be executed one at a time, the issue logic waiting until each of these instructions has finished execution before issuing any other instruction. In a microprocessor that retires instructions out of program order, these difficult to predict instruction are dealt with using the logic which allows instructions to retire out of order. However, the logic which allows instructions to retire out of order is relatively complex and consumes more power and die area than is desirable in some applications.

The decode/issue logic 30 will identify when an instruction falls within the class of instructions for which it is not easy to reliably predict when resources associated with those instructions will become available. Typically, a simple combinatorial decode logic is provided to identify such instructions whose main input is the incoming instruction. The decode/issue logic 30 will further identify when an instruction falls within a known sub-class of instructions for which it is not easy to reliably predict when correct results will be obtained but for which it is known a correct result will be obtained as long as a run of instructions falling within the sub-class are issued without any instructions falling outside the subclass being issued during the run. Instructions within the class and the sub-class can be predetermined based on the configuration and likely operation of the data processing apparatus 10 and programmed into the decode/issue logic 30.

Inhibit override logic 60 is provided which detects when an instruction to be executed is identified as being a member of the sub-class. The inhibit override logic 60 also detects whether a subsequent instruction (the next or immediately succeeding instruction) which is waiting to be issued to begin execution has also been identified as being a member of the sub-class and, if that subsequent instruction is also one which falls within the defined sub-class, then the inhibit override logic 60 will cause that subsequent instruction also to be issued by the decode/issue logic 30 at the appropriate time, and so on. In each case the scoreboard 40 may not be updated to provide any indication of when the resources associated with those instruction will become available since it is not practical to make such a prediction.

Once it is detected that the succeeding instruction has not been identified as falling within the sub-class then the inhibit override logic 60 allows the decode/issue logic 30 to prevent that instruction from issuing. Hence, the issued instructions will be allowed to execute and subsequent instructions will be stalled until an indication has been provided that all the instructions have been executed. A signal is provided to the decode/issue logic 30 which indicates when the pipeline is empty and further signals are provided indicating when other devices have no instructions left to execute. Once this indication is received then the decode/issue logic 40 will enable the subsequent instruction to be issued and will update the scoreboard logic 40 as appropriate.

This approach reduces the latency problem caused by waiting for the instruction in the sub-class and all other outstanding issued instructions to be executed prior to issuing the next instruction. This has particular performance benefits since it is often the case that instructions falling within the sub-class will occur in sequential bursts in the program. Hence, in these circumstances, the instructions can be issued in successive clock cycles instead of having to wait until an instruction has been retired prior to issuing the next instruction and then waiting until that instruction has been retired to issuing the next instruction, and so on.

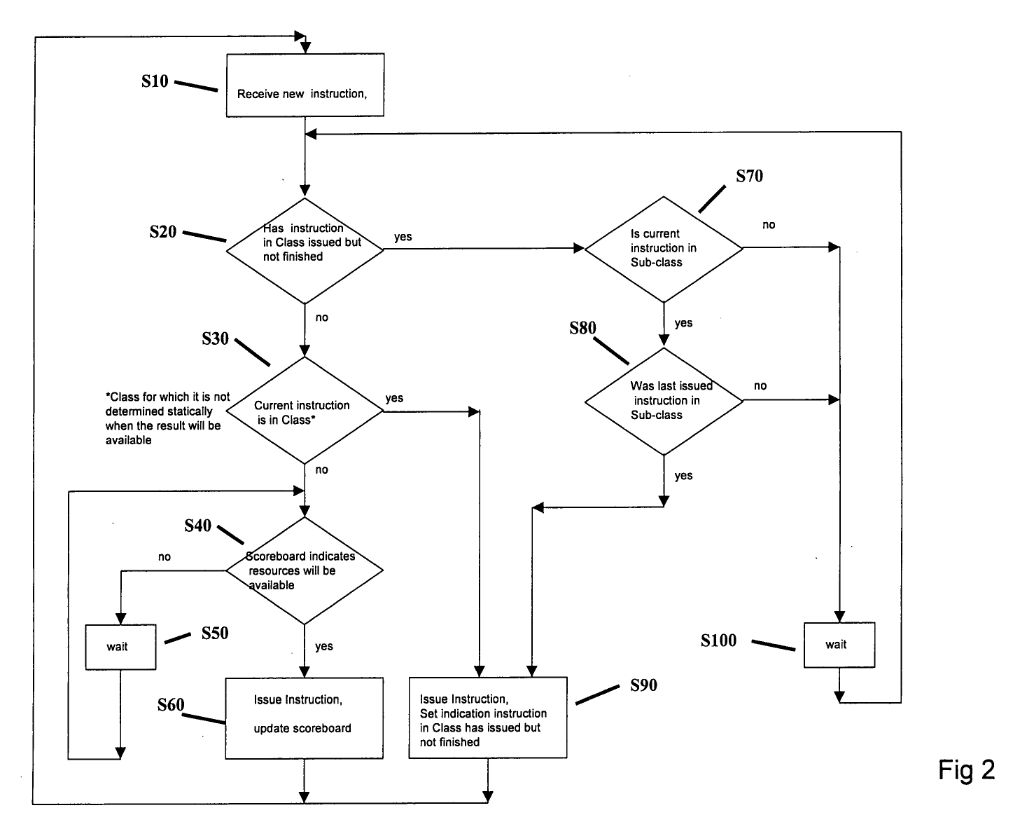

FIG. 2 is a flow chart illustrating the operation of the decode/issue logic 30 incorporating the inhibit override logic 60.

At step S10, decode logic (not shown) within the decode/issue logic 30 decodes an instruction received from the fetch logic 20 for issuing to subsequent stages in the pipeline.

At step S20, if it is determined that it is the case that a previously issued instruction that falls within the class of instructions for which it is not determined when the result will be available has not finished, then processing proceeds to step S70 otherwise processing proceeds to step S30.

At step S30, the decode logic 30 determines whether the current decoded instruction is one which falls within the class of instructions for which it is not determined when the result will be available. If it is determined that the current decoded instruction is not one such instruction then processing proceeds to step S40 otherwise processing proceeds to step S90.

At step S40, the decode/issue logic will determine by reference to the scoreboard whether the current decoded instruction can be issued in that cycle. In the event that the current decoded instruction can not be issued in that cycle then processing will proceed to step S50.

At step S50, the decode/issue logic 30 will wait and no instruction will be issued in that cycle.

In the event that it is determined at step S40 that the current decoded instruction can be issued in that cycle then processing will proceed step S60 and the current decoded instruction is issued and the scoreboard 40 updated for the destination result registers of that instruction.

Thereafter, processing will return to step S10 to await the next instruction.

At step S70 a determination is made whether the current decoded instruction belongs to a sub-class of instructions which can be guaranteed to execute correctly regardless of when the results of other instructions that have been issued but not completed are available. This is guarantee is possible provided that all instructions between the instruction about to issue (the current decoded instruction) and the oldest instruction that has been issued but not completed, upon which a dependency exists, are also in the sub-class. If it is determined that the current decoded instruction belongs to the sub-class of instructions then processing continues to step S80 otherwise processing proceeds to step S100

At Step S80 a determination is made whether the previously issued instruction belonged to the same sub-class of instructions which can be guaranteed to execute correctly regardless of when the results of other instructions that have been issued but not completed are available, provided that all instructions between the current decoded instruction and the oldest instruction that has been issued but not completed, upon which a dependency exists, are also in the sub-class. If it is determined that the current decoded instruction belongs to the sub-class of instructions then the inhibit override logic 60 will enable processing to continue to step S90 otherwise processing proceeds to step S100.

At step S90, the current decoded instruction is issued and the scoreboard 40 is not updated for the destination result registers of the current decoded instruction. An indication is set that an instruction has issued that falls within the class of instructions for which it is not determined when the result will be available, and the execution of that instruction has not yet finished.

Thereafter, processing will return to step S10 to await the next instruction.

At step S100, the decode/issue logic 30 will wait and no instruction will be issued in that cycle. Thereafter, processing will return to step S20.

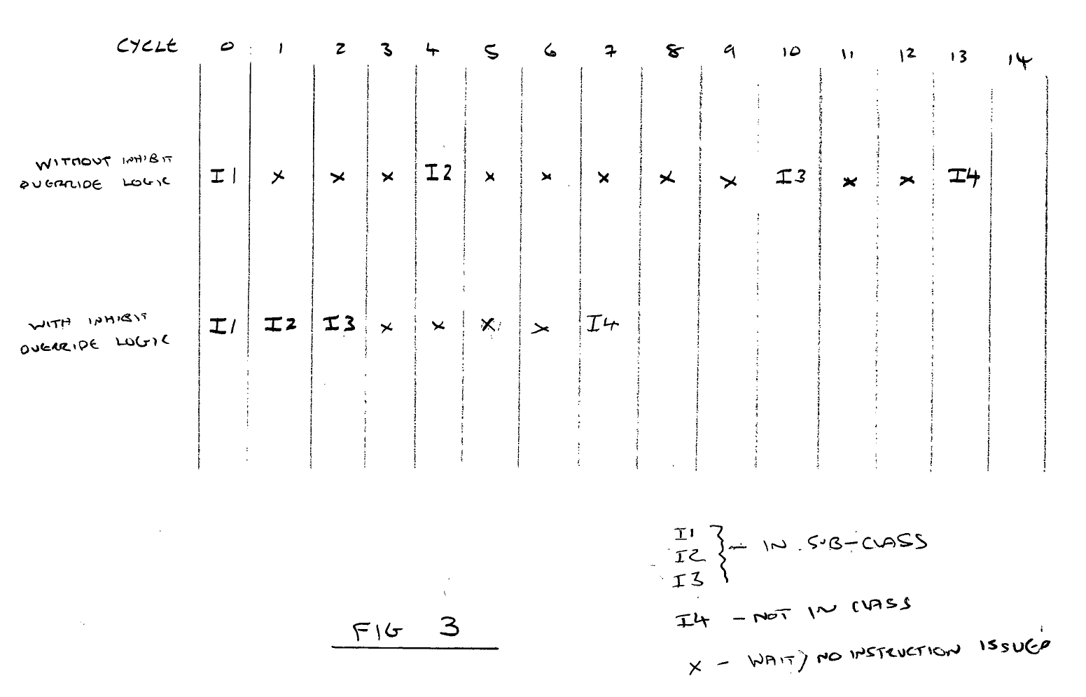

FIG. 3 illustrates in more detail the operation of the decode/issue logic 30 when issuing instructions. The timing of instructions issued by the decode/issue logic 30 is shown and compared with the timing of the same instructions which would be issued by an equivalent arrangement which does not utilise the inhibit override logic 60.

Firstly considering the arrangement which doe not use inhibit override logic 60.

At clock cycle 0, an instruction I1 is received by the decode/issue logic 30 which determines that it is an instruction in the class of instructions for which it is not easily determined when the result will be available. Hence, the decode/issue logic will stall all subsequent instructions until instruction I1 completes.

Assuming that the instruction I1 completes within three cycles then, at cycle 4, a signal will be received indicating that instruction I1 has completed and the decode/issue logic will then issue instruction I2. The decode/issue logic determines that instruction I2 is also an instruction in the class of instructions. Hence, the decode/issue logic will stall all subsequent instructions until instruction I2 completes.

Assuming that that instruction I2 takes 5 cycles to complete then the decode/issue logic will prevent instruction I3 from issuing until cycle 10. The decode/issue logic determines that instruction I3 is also an instruction in the class of instructions. Hence, the decode/issue logic will stall all subsequent instructions until instruction I3 completes.

Assuming instruction I3 completes in 2 cycles then at cycle 13 instruction 4 can be issued.

Assuming instruction I4 is not an instruction in the class of instructions then subsequent instructions can be issued in the normal way, providing there is no dependency issues between those subsequent instructions and instruction I4.

Hence, in this illustrative example, issuing the four instructions takes 14 cycles.

Now considering the arrangement which uses inhibit override logic 60.

In this case, the instruction I1 is received at cycle 0 and decoded by the decode/issue logic 30. A determination is made that instruction I1 is an instruction in the sub-class of instructions for which it is not determined when the result will be available, but which can be guaranteed to execute correctly regardless of when the results of other instructions that have been issued (but not yet completed) are available, provided that all instructions between instruction I1 and the oldest instruction not yet completed are in the sub-class. A determination is made that that there are no other instructions being executed. Accordingly, at the end of cycle 0, the instruction I1 is issued.

In the next cycle, instruction I2 is received and decoded by the decode/issue logic 30. It is determined that instruction I2 falls within the same sub-class, that the previously issued instruction (I1) also falls within the same sub-class and so, at the end cycle 1, instruction I2 is issued.

In cycle 2, instruction I3 is received and decoded by the decode/issue logic 30. It is determined that instruction I3 falls within the same sub-class, that the previously issued instruction (I2) also falls within the same sub-class and so, at the end cycle 1, instruction I3 is issued.

In cycle 3, instruction I4 is received and decoded. A determination is made that instruction I4 does not fall within the sub-class. Hence instruction I4 can not be issued at then end of cycle 3. Instruction I4 must wait until instruction I1, I2 and I3 have completed.

Hence, the front of the pipeline will be stalled until cycle 7 when instructions I1, I2 and I3 will all have been completed. Accordingly, the decode/issue logic 30 will determine that instruction I4 can now be issued and so instruction I4 will issue in cycle 7. Subsequent instructions can then issue in the normal way.

Hence, as shown in FIG. 3, whereas the arrangement which does not use the inhibit override technique would take 14 cycles to complete, the arrangement according to embodiments which utilise the inhibit override logic 60 can complete in just eight cycles.

Whilst, for ease of illustration, FIG. 3 assumes relatively low execution times for instructions in the class, it will be appreciated that in fact these instructions will take significantly longer to execute and would typically take tens or even hundreds of clock cycles to complete. Accordingly, it will be appreciated that this arrangement provides significant performance benefits over existing techniques.

Also, as mentioned previously, the present technique recognises that often instructions falling within the sub-class of instructions occur in bursts. These bursts typically occur because instructions falling within this sub-class are often used to transfer large amounts of data between the processor core and peripheral or slave devices such as a digital signal processors, video processors, audio processors, co-processors, or higher level memory devices. Hence, instead of issuing each instruction singly, waiting the latency time for accessing the data, transferring the data and then only thereafter issuing the next instruction, it is possible to sequentially issue these instructions, back to back, until an instruction is received which does not fall within the sub-class. It will be appreciated that when these instructions occur in sequential bursts, after waiting just one set up period the data associated with these instructions can be transferred in each subsequent cycle.

Although a particular embodiment of the invention has been described herewith, it would be apparent that the invention is not limited thereto, and that many modifications and additions may be made in the scope of the invention. For example, various combinations of the features of the following dependent claims could be made with features of the independent claims without departing from the scope of the present invention.

We claim:

1. A data processing apparatus operable to process instructions and operable to determine, prior to each instruction being issued for execution, when resources associated with that instruction are predicted to be available for use by succeeding instructions, said data processing apparatus comprising:
scoreboard logic operable to store an indication of when resources associated with an instruction to be issued are predicted to be available for use by succeeding instructions;
issue logic operable to determine, by reference to said scoreboard logic, when said instruction can be issued for execution, said issue logic being further operable in the case that said instruction falls within a class of instructions which have been designated as instructions for which it is uncertain when resources associated with those instructions will be available for use by succeeding instructions, to prevent succeeding instructions from issuing until all preceding instructions have been executed; and
inhibit override logic operable to detect when said instruction to be issued falls within a sub-class of instructions, to review an immediately succeeding instruction and, in the event that said immediately succeeding instruction also falls within said sub-class of instructions, to cause said issue logic to enable said succeeding instruction to be issued for execution even when all preceding instructions have not been completed.

2. The data processing apparatus as claimed in claim 1, wherein said inhibit override logic is operable, in the event that each immediately succeeding instruction also falls within said sub-class of instructions, to cause said issue logic to sequentially issue each immediately succeeding instruction falling within said sub-class of instructions until an instruction not falling within said sub-class of instructions is encountered.

3. The data processing apparatus as claimed in claim 2, wherein once said instruction not falling within said sub-class is encountered, said inhibit override logic is operable to cause said issue logic to prevent that instruction and succeeding instructions from issuing until all preceding instructions have been executed.

4. The data processing apparatus as claimed in claim 1, wherein said class of instructions includes those instructions where the time taken to modify architectural state associated with those instructions can not be accurately predicted just from decoding the instruction.

5. The data processing apparatus as claimed in claim 1, wherein said class of instructions includes those instructions having a variable execution time which can not readily be determined prior to the instruction being issued for execution.

6. The data processing apparatus as claimed in claim 1, wherein said class of instructions includes those instructions for which the likelihood of accurately predicting when resources associated with those instructions will be available for use by succeeding instructions is lower than the likelihood of not accurately predicting when resources associated with those instructions will be available for use by succeeding instructions.

7. The data processing apparatus as claimed in claim 1, wherein said sub-class of instructions includes those instructions which require data to be accessed in a slave device.

8. The data processing apparatus as claimed in claim 1, wherein said sub-class of instructions includes those instructions which require data to be accessed in a slave device and the time taken for the slave to respond varies depending on the number of pending instructions in that slave device.

9. The data processing apparatus as claimed in claim 1, further comprising a processor core, said scoreboard logic, said issue logic and said inhibit override logic being provided as part of said processor core and wherein said class of instructions includes instructions which cause a data transfer to occur from a slave device to said processor core.

10. The data processing apparatus as claimed in claim 9, wherein said sub-class of instructions includes those instructions which cause no change in the architectural state associated with said processor core.

11. The data processing apparatus as claimed in claim 9, wherein said sub-class of instructions includes those instructions which only change the architectural state of said slave device.

12. The data processing apparatus as claimed in claim 1, wherein said issue logic is operable to receive an indication of whether said instruction falls within said class of instructions.

13. The data processing apparatus as claimed in claim 12, wherein said issue logic is operable to receive from decode logic said indication of whether said instruction falls within said class of instructions.

14. The data processing apparatus as claimed in claim 1, wherein said resources include registers or memory operable to store operands associated with instructions.

15. The data processing apparatus as claimed in claim 9, wherein said resources include logic operable to execute instructions.

16. A data processing apparatus for processing instructions and for determining, prior to each instruction being issued for execution, when resources associated with that instruction are predicted to be available for use by succeeding instructions, said data processing apparatus comprising:
scoreboard means for storing an indication of when resources associated with an instruction to be issued are predicted to be available for use by succeeding instructions;
issue means for determining, by reference to said scoreboard logic, when said instruction can be issued for execution, for preventing, in the case that said instruction falls within a class of instructions which have been designated as instructions for which it is uncertain when resources associated with those instructions will be available for use by succeeding instructions, succeeding instructions from issuing until all preceding instructions have been executed; and
inhibit override means for detecting when said instruction to be issued falls within at least part of said class of instructions, for reviewing an immediately succeeding instruction and, in the event that said immediately succeeding instruction also falls within said at least part of said class of instructions, for causing said issue means to enable said succeeding instruction to be issued for execution even when all preceding instructions have not completed execution.

17. A method of processing instructions comprising:
storing an indication of when resources associated with an instruction to be issued are predicted to be available for use by succeeding instructions;
determining, by reference to said indication, when said instruction can be issued for execution;
preventing, in the case that said instruction falls within a class of instructions which have been designated as instructions for which it is uncertain when resources associated with those instructions will be available for use by succeeding instructions, succeeding instructions from issuing until all preceding instructions have been executed; and
detecting when said instruction to be issued falls within a sub-class of instructions, reviewing an immediately succeeding instruction and, in the event that said immediately succeeding instruction also falls within said sub-class of instructions, causing said succeeding instruction to be issued for execution even when all preceding instructions have not been completed.
